(19) United States
(12) Patent Application Publication
(10) Pub. No.: US 2013/0307183 A1
(43) Pub. Date: Nov. 21, 2013

(54) INJECTION MOLDING METHOD AND INJECTION MOLDING DEVICE

(71) Applicant: Reiner Rohlje, Olpe (DE)

(72) Inventor: Reiner Rohlje, Olpe (DE)

(73) Assignee: WIRO PRÄZISIONS-WERKZEUGBAU GMBH & CO.KG, Olpe (DE)

(21) Appl. No.: 13/982,212

(22) PCT Filed: Dec. 5, 2011
(86) PCT No.: PCT/EP2011/071703

§ 371 Date: Jul. 26, 2013

(30) Foreign Application Priority Data
Jan. 28, 2011 (DE) 102011000397.5

(51) Int. Cl. B29C 45/00

(52) U.S. Cl. CPC B29C 45/0003
USPC 264/255; 264/328.7; 425/518

(57) ABSTRACT

An injection molding device, includes a first mold which has an injection material channel and a second mold defining a first cavity in which a first product part can be injection-molded. The first mold can be moved in a direction different from the mold opening direction. In this manner, especially two-component products can be produced, the first mold together with the first product part being moved to a third mold section with which a second cavity for injection of another injection material is defined.

The invention relates to an injection molding method and an injection*molding device with which injection molding products can be produced.

Injection molding devices generally consist of (at least) two mold parts, which can be joined to form a cavity into which injection material can be introduced. After solidification of the injection molding material, the mold parts are moved apart wherein the direction of this movement in the following is referred to as machine opening direction or synonymous form opening direction.

From DE 196 50 854 C1 an injection molding device for producing products from two different materials is known. This injection molding device includes a movable mold part and a stationary mold part. The product part, which is molded in a first molding step from the stationary mold part, is moved together with the movable mold part to a further mold section of the stationary mold part where a second cavity is formed. A further injection material is then molded on from the stationary mold part.

Given this background it was an object of the present invention to provide means for a more flexible production of injection molding products, in particular of products which contain two, three or more components.

This object is solved by an injection molding method according to claims 1 and 2 and by an injection molding device according to claim 3. Advantageous embodiments are contained in the sub claims.

According to a first general aspect, the invention relates to an injection molding method in which a first mold part with an injection material channel and a second mold part are moved apart in the associated mold opening direction and in which the first mold part is then moved in a direction different from the mold opening direction.

The aforementioned movement “in a direction different from the mold opening direction” can generally be part of any (i.e., straight and/or curved) path, wherein this path however has a tangent at at least one point which is not parallel to the mold opening direction.

The injection molding method according to a second aspect of the invention serves for producing a product from (at least) one material referred to as injection material, which can be introduced in the flowable state into a forming cavity where it can solidify. In particular, the injection material can be a thermoplastic plastic and/or a material that cures in response to supplying heat. The injection molding method includes the following steps:
A first product part is molded in the (first) cavity, which is formed between a first pair of mold regions of a first mold part and a second mold part.
The first mold part and the second mold part are moved apart in the form opening direction. The mold opening direction (or “machine opening direction”) is constructively predetermined by the shape of the mold parts and their mold regions. Further, the mold parts move relative to each other, i.e. relative to the environment one of the mold parts can remain still (stationary) during the opening. Further this movement in mold opening direction is typically (at least approximately) straight.
The first mold part, which has to contain an injection material channel, is subsequently moved in a different direction than the mold opening direction. This movement can occur on any (i.e., straight and/or curved) path. The injection material channel serves for supplying the flowable injection material to a mold region and preferably maintains the injection material flowable also during the movement of the mold parts. This channel is also synonymously referred to as “hot channel”.
The first mold part is subsequently joined with the second mold part or a third mold part so that a second pair of mold regions of the first mold part and the second or third mold part forms a third cavity in which the produced first product part comes to lie. Typically, the second cavity is formed (inter alia) by a mold region, which was also involved in the forming of the first cavity.
In the aforementioned second cavity, a second product part is molded onto the first product part. For this, in particular a different injection material can be used than in the first molding step. Further, the injection material is delivered in the second injection step via a different injection material channel than the injection molding material in the first injection step.
According to a third aspect, the invention relates to an injection molding device, in particular an injection molding device with which one of the above explained methods can be carried out. The injection molding device includes the following components:
A first mold part with an injection material channel through which injection molding material can be delivered in a flowable state and which preferably maintains the injection molding material flowable also during the movement of the mold parts.
A second mold part. The first and second mold parts each have (at least) one mold region in a known manner which can be joined to form a cavity. Further, the second mold part preferably also has an injection material channel.

The injection molding device is further characterized in that:
The first and the second mold part can be moved apart in the associated mold opening direction to open the aforementioned cavity;
The first mold part can be moved (operatively, i.e., during the injection process) in a different direction than the mold opening direction.

The described injection molding methods and the injection molding device are all characterized by the idea that a first mold part can be moved in a different direction than the conventional mold opening direction. This possibility appears disadvantageous at first sight because the movement of an injection material channel presumably leads to problems during delivery of the injection material which is under (high) pressure. In addition, an injection material channel typically requires a complicated control of the conditions present there for example the temperature. Also with regard to this it is disadvantageous to move the injection molding material cannel. In contrast, the present invention is based on the recognition that by arranging an injection material channel in a mold part, which can be moved in a different direction than the mold opening direction, significant advantages can be realized. These advantages relate in particular to the more flexible design of the produced products for example with regard to the position of the injection points.

Due the close relationship between the described injection molding methods and injection molding devices explanations which were given for one of these items also always apply for the others.

In the following, different preferred refinements of the invention are described which can be realized in the above injection molding methods and also in the injection molding device.

As already explained, the first form part of the injection molding device normally has a first mold section and the second mold part a second mold section, wherein these rom regions in the joined state of the mold parts form a first cavity in which a first product part can be injected.

In addition, a third mold section is preferably present, which together with the first mold section of the first mold part or the second mold section of the second mold part in the joined state can form a second cavity in which a second product part can be molded to a first product part which the first product part is preformed in the second cavity. With such an injection molding device in particular a two component (2K) product can be produced, wherein the first product part is formed by the first component and the second product part is formed by the second component.

The first product part, which is produced in the first cavity, can in principle be introduced into the second cavity in any desired manner for example via a separate transport mechanism. Preferably the first product part, which is produced in the first cavity, is carried along by the first mold part during movement of the first mold part. As an alternative, after its production the first product part can also remain in the second mold section (of the second mold part) if the second mold section takes part in the forming of the second cavity.

The “third mold section” mentioned above can optionally be formed on the second mold part. This means, that at the same (one-piece) second mold part two different mold sections are formed which can be joined with the first mold section of the first mold part to result in the first cavity or to the second cavity.

As an alternative, the “third mold section” can also be formed on the first mold part. This means that at the same (one-piece) first mold part two different mold sections are formed which can be joined with the second mold section of the second mold part to result in the first cavity or to the second cavity.

Further, the third mold section” can also be formed on a separate third mold part.

According to another embodiment of the invention, an additional mold section (beside the already mentioned first, second and third mold sections) is provided which can be joined with a mold section of the first mold part, the second mold part or optionally the third mold part. In this way the production output can be increased because in a machine cycle the mentioned additional mold section can in parallel form a respective further cavity in which a product (part) can be injected.

The aforementioned additional mold section can for example be provided on the first mold part. While the first mold section (of the first mold part) forms a cavity with the second mold section (of the second mold part) the additional mold section (of the first mold part) can then simultaneously also form a cavity with the third mold section (of the second mold part). Subsequently the roles of the first mold section and the additional mold section can be switched. In each cycle an injection process can take place at each mold section.

According to another refinement of the invention, at least one additional mold part (beside the first, second and as the case may be the third mold part) is present, which carries the above mentioned additional mold section. In this way, for example a so-called stack mold can be realized in which injection processes can take place in one cycle on the first or second mold part in different opening planes simultaneously. The additional mold part can for example be configured analogous to the first mold part, i.e., have an injection material channel and can be movable in a direction, which is different from the associated (i.e., relative to the additional mold section) mold opening direction.

Two mold sections, which can form a cavity together, are preferably respectively provided in multiples. In particular, both can be provided (at least) n*m-fold, wherein n and m are natural numbers at least one of which is greater than one. When arranging these n*m mold sections in a mutually matching grid, n*m cavities can then be formed in which n*m product parts can be simultaneously injected. The output of the device or the method can correspondingly be multiplied. The numbers n and m can in particular describe an arrangement of the mold sections in a grid with n rows and m columns.

As mentioned, the movement of the first mold part, which is to occur in a different direction than the form opening direction, can also be part of a completely or partially curved path. In particular, the complete movement can be a rotation about a predetermined axis and/or a spiral-shaped movement, wherein in particular at least one tangential component of this movement is to lie in a different direction than the mold opening direction.

In order to remain flowable, injection material in an injection material channel typically has to be supplied under defined conditions. In this regard, a temperature control unit can preferably be provided in a mold part (the first, second, third and/or a further one), with which the temperature of an injection material channel which is present in the mold part can be controlled during delivery of injection material (i.e., can be control by closed loop or open loop control according to a predetermined target value).

The temperature control unit can optionally include a heating in order to ensure sufficiently high temperatures of for example a thermoplastic injection molding material. In addition or as alternative, the temperature control unit can also include a cooling in order to prevent exceeding a defined temperature in the injection molding material. The latter is for example required in materials such as silicon, which have to be conducted in cool, liquid state and solidify in the (typically heated) cavity under the influence of heat.

Advantageously, temperature control units with opposite effects are accommodated in different mold parts so that their influence on each other is as little as possible. In particular a temperature control unit with a heating can be arranged in one mold part (the first mold part) and a temperature control unit with a cooling can be arranged in a different (for example the second) mold part.

In the following, the invention is explained in more detail by way of the figures. It is shown in:

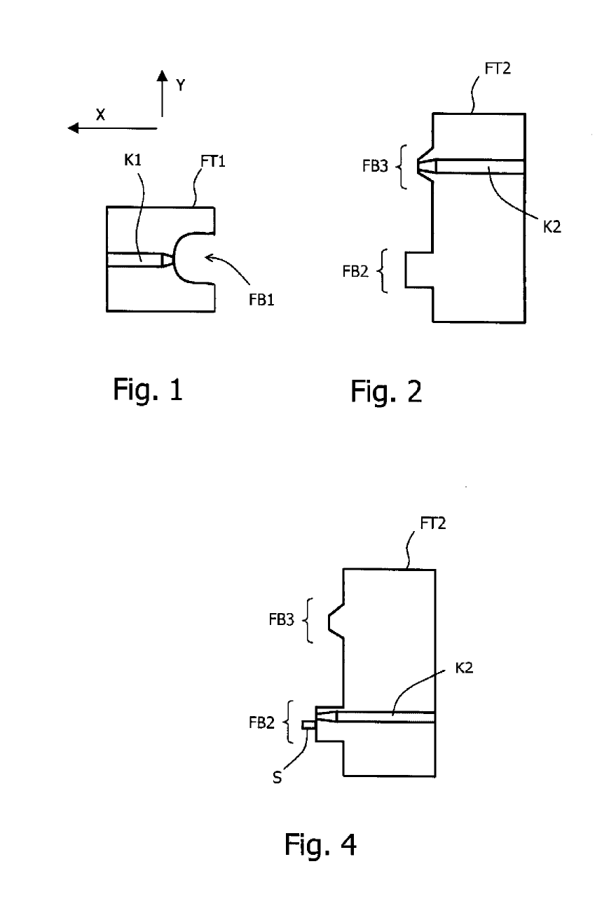

FIG. 1 a schematic side view of a first mold part according to the present invention.

FIG. 2 a schematic side view of a second mold part according to the present invention, which has an injection molding material channel for the material of the second product part;

FIG. 3 sequential steps of a n injection process with the first mold part of FIG. 1 and the second mold part of FIG. 2;

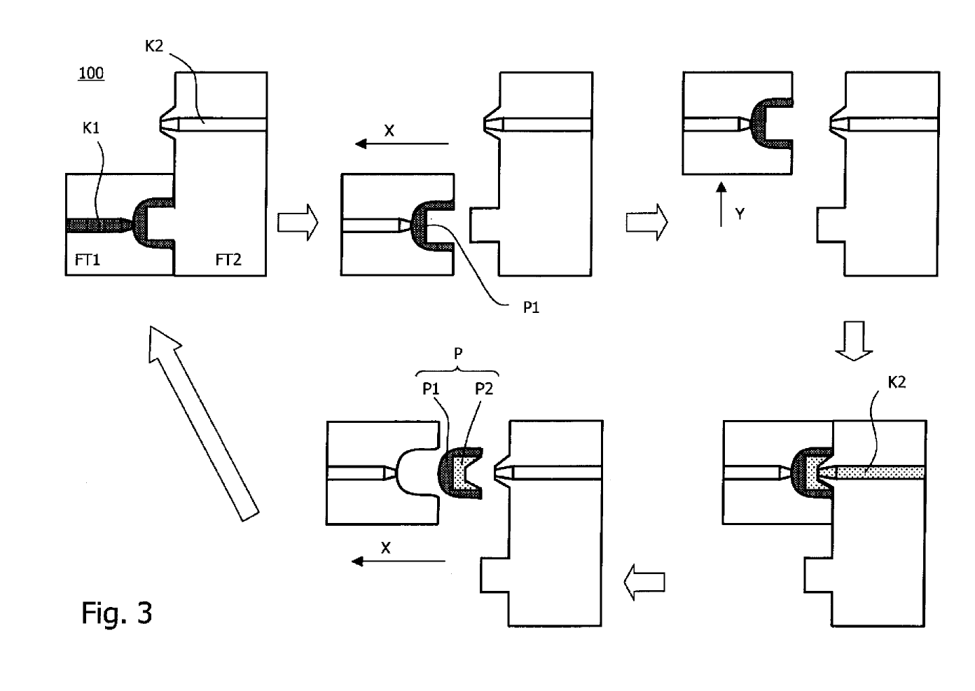

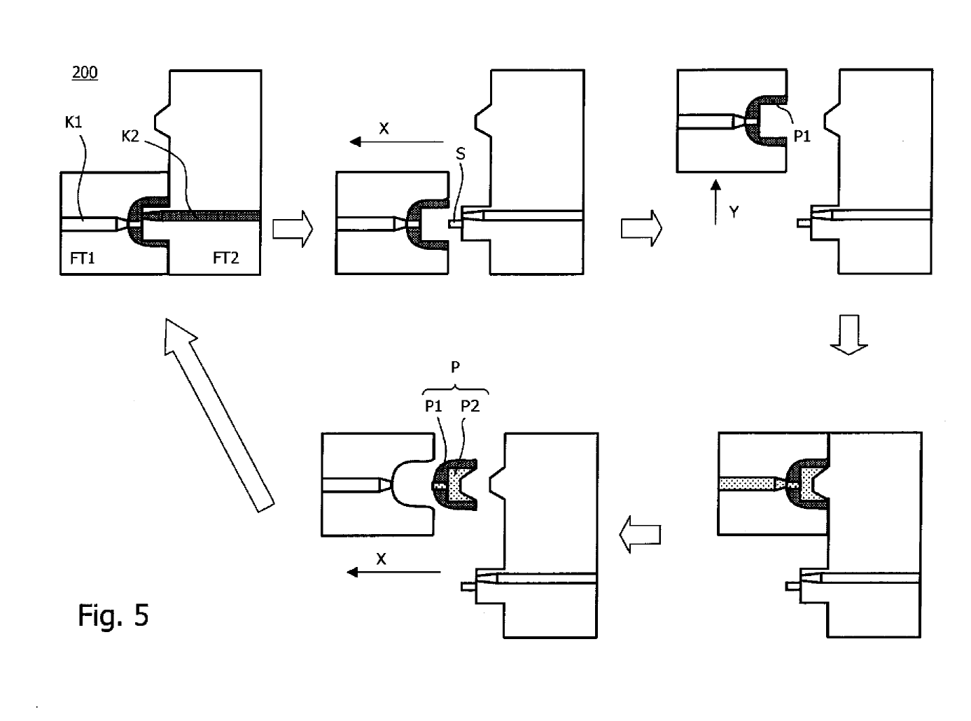

FIG. 4 a modification of the second mold part of FIG. 2, which has an injection molding material channel for the material of the first product part;

FIG. 5 sequential steps of an injection process with the first mold part of FIG. 1 and the second mold part of FIG. 4;

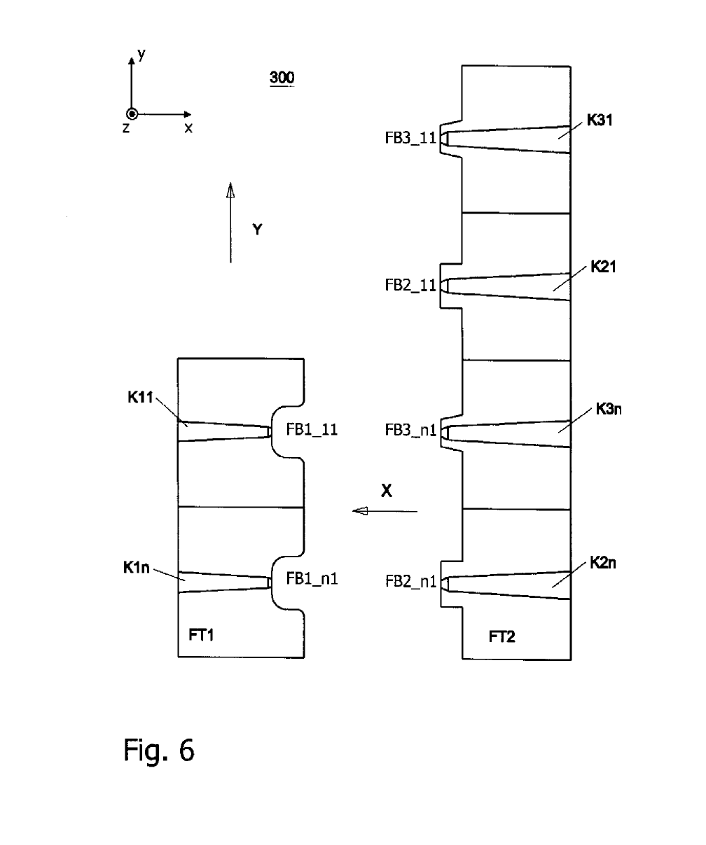

FIG. 6 an injection molding device analogous to FIG. 3, in which corresponding mold sections are repeated n*m fold;

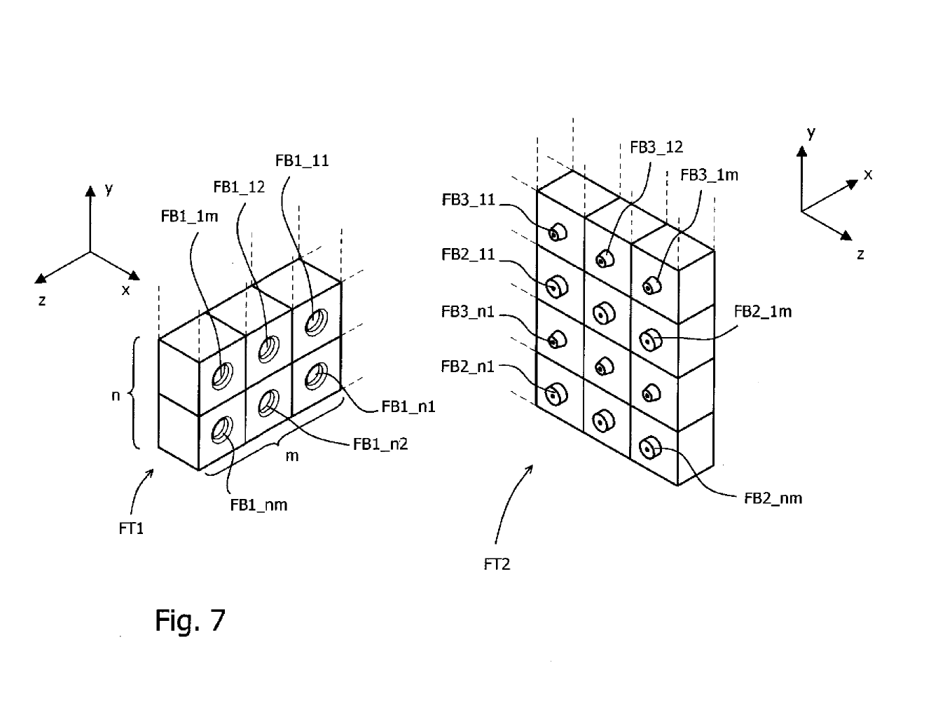

FIG. 7 a perspective view of the mold parts of FIG. 6;

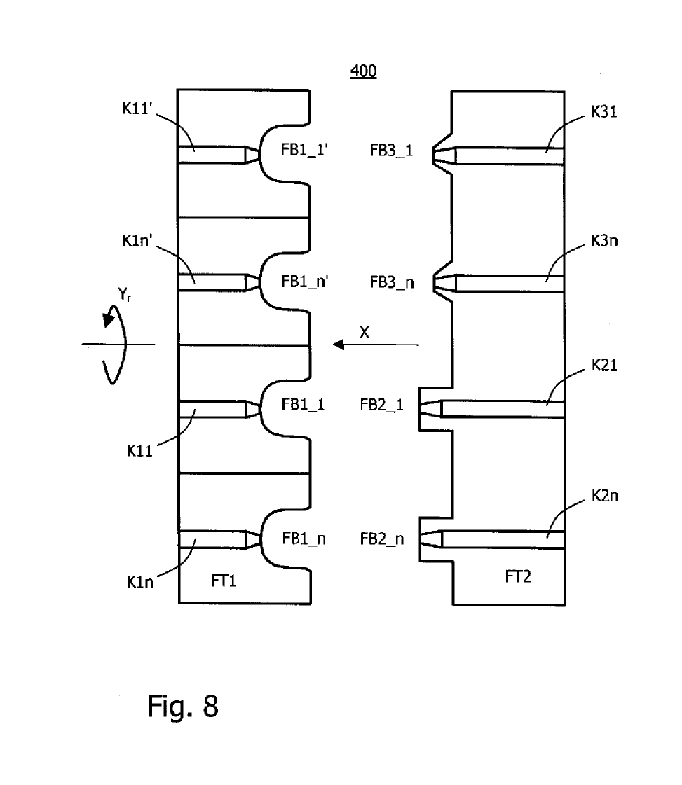

FIG. 8 an injection molding device which results from the doubling of the first mold part of the injection molding device of FIG. 6;

FIG. 9 an injection molding device with a second mold part and a separate third mold part;

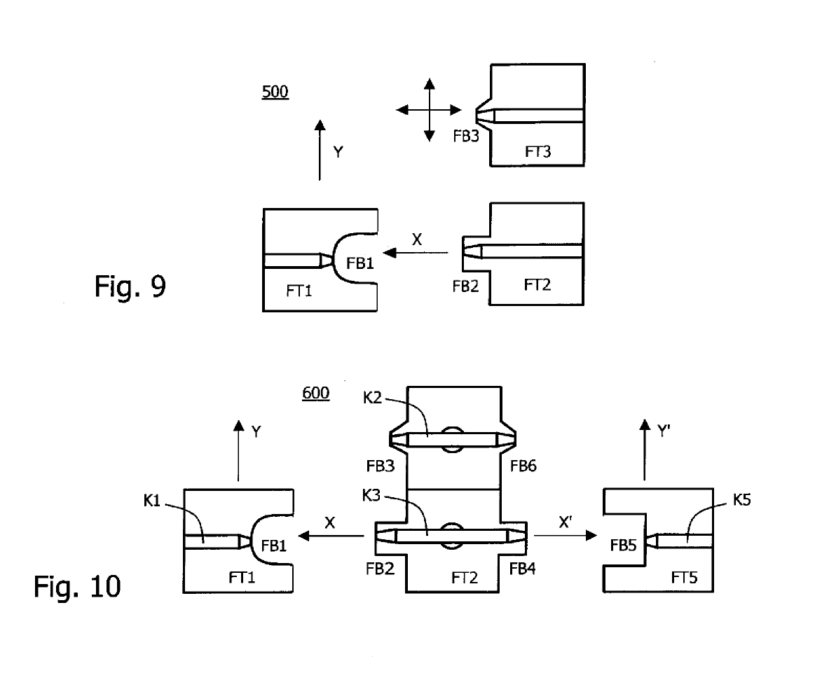

FIG. 10 an injection molding device with an additional mold part form forming a stack mold;

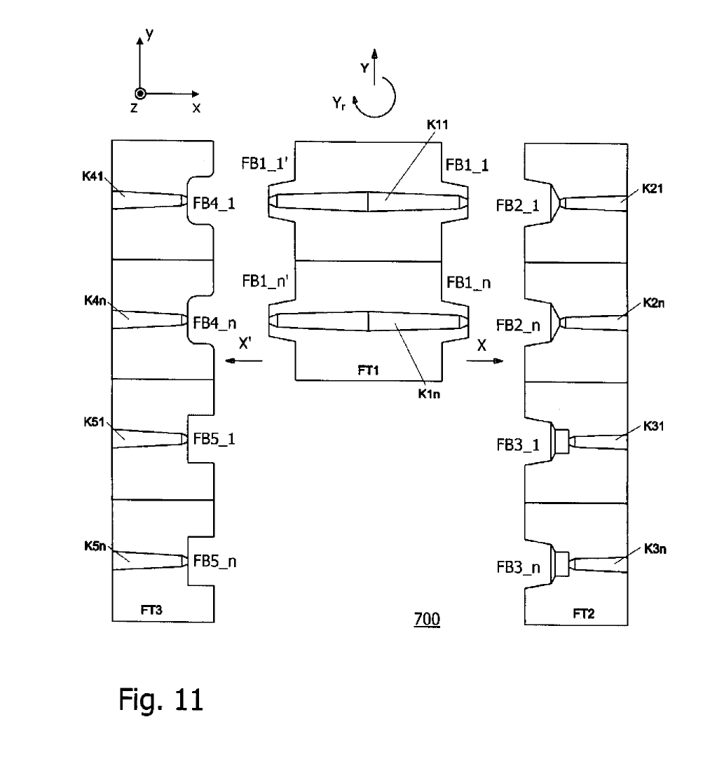

FIG. 11 an injection molding device in the form of a stack mold for procuring a multicomponent product;

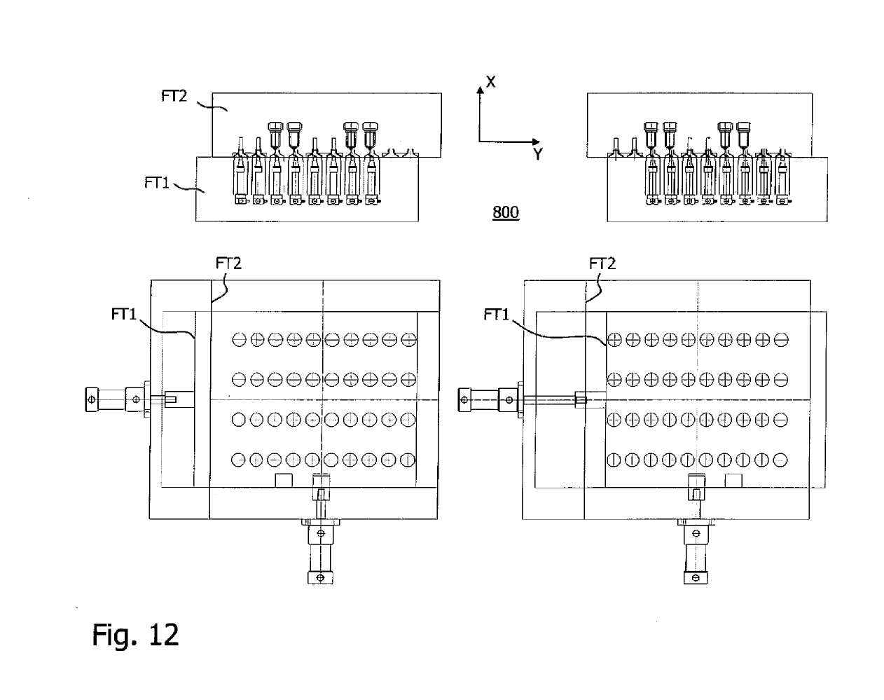

FIG. 12 the construction drawing of a real injection molding device according to the present invention;

FIG. 3 shows the operation of an injection molding device 100 according to a first embodiment of the present invention in a schematic sectional view. The injection molding device 100 is formed by a first mold part FT1, which is shown separately in FIG. 1 and an associated second mold part FT2 which is shown separately on FIG. 2.

The first mold part FT1 has a first mold section FB1, to which a first injection material channel K1 leads. The first mold part FT1 is to be movably supported inside the injection molding device 100, i.e., at least movable in a direction Y which is different from the mold opening direction X (horizontal in FIG. 3).

The second mold part FT2 has a second mold section FB2 and a third mold section FB3 which can be alternatively joined with the first mold section FB1 of the first mold part FT1 to form a first or to a second cavity. In the shown example, the second mold part FT2 further has an injection material channel K2, which leads to the third mold section FB3.

FIG. 3 schematically shows five successive steps of the production of a 2 component product P with the injection molding device 100. In step 1 (top left hand side) a first product part P1 is injected in the first cavity between the first pair of the mold sections FB1 and FB2 or the two mold parts FT1 and FT2, wherein the injection material is delivered through the injection material channel K1 of the first mold part FT1.

Then, the form is opened (step 2 top center) for which the first mold part FT1 (and/or the second mold part FT2) is moved in mold opening direction X.

Important is then the third step (top right hand side) in which the first mold part FT1 (and/or the second mold part FT2) is moved in a direction Y perpendicular to the mold opening direction X, in order to align another pair of mold sections FB1 and FB3 of the mold parts FT1 and FT2 with each other. The second product part P2 is then injected in the then formed second cavity between these mold sections FB1 and FB3 (4. Step bottom right). The injection material is delivered through the injection material channel K2 in the second mold part.

After removal of the finished product P in step 5 (bottom left) the cycle can start from the beginning. In this embodiment of the invention, the first mold part FT1 is thus moved linearly back and forth in Y-direction. Alternatively, the second mold part FT2 can also take over this movement or a part thereof.

FIG. 5 shows an alternative embodiment of a second injection molding device 200, which is formed from the first mold part FT1 according to FIG. 1 and a second mold part FT2 according to FIG. 4. The second mold part FT2 of FIG. 4 differs from the one of FIG. 2 in that its injection material channel K2 leads to the second mold section FB2 (instead to the third). Further, the second mold section FB2 has a through passage free holder S, whose function can be seen from FIG. 5.

FIG. 5 schematically shows five successive steps of the production of a two component product P with the injection molding device 200. In step 1, (top left) a first product part P1 is injected in the first cavity between the first pair of the mold sections FB1 and FB2 of the two mold parts FT1 and FT2, wherein the injection material is supplied through the injection material channel K2 of the second mold part FT2. The outlet of the injection material channel K1 in the first mold part FT1 is covered by the through passage free holder S.

Then, the form is opened (step 2 top center) for which the mold part FT1 (and/or the second mold part FT2) is moved in mold opening direction X. Due to the through passage free holder S a through passage in the generated first product part P1 is open from the back side (i.e., the outlet of the injection molding material channel K1) toward the front side.

In the third step, (top right) the first mold part FT1 (and/or the second mold part FT2) is again moved in a direction Y perpendicular to the mold opening direction X in order to align the mold sections FB1 and FB3 of the mold parts FT1 and FT2. In the then formed second cavity between these mold sections FB1 and FB3 the second product P2 is then molded to the first product part P1 which is situated in the cavity (4. Step bottom right). Hereby the injection molding material is delivered through the injection material channel K1, wherein it reaches the front side of the product part P1 through the held free through passage in the first product part P1.

After removal of the finished product P in step 5 (bottom left) the cycle can start from the beginning.

Of course, the injection molding device 200 can be modified in different ways. For example, the through opening free holder S can also be formed on the first mold part FT1.

FIGS. 6 and 7 show an injection molding device 300 in which the first mold part FT1 has a number of On (preferably identical) mold sections FB_11, . . . FB1_nm, wherein the case n=2 and m=3 is shown. The mold sections are arranged in n rows arranged on top of each other (y direction) and m columns which are situated next to each other (z-direction). It should be noted that in FIG. 7 the two mold part FT1, FT2 are shown rotated for better recognition i.e., they are parallel to each other in the operative state.

The second mold part FT2 also contains a number of 2n*m mold sections FB2_11, . . . FB2_nm, FB3_11, . . . FB3_nm of two different kinds, half of which can be aligned with the mold sections of the first mold part FT1 when the first mold part moves in (±Y) direction. In the shown example, a respective row of m identical mold sections of the first kind (for example the top most row FB3_11, FB3_12, . . . FB3_1m) which extends in z direction is arranged alternatingly with a row of m identical mold sections of the second kind (for example second top most row of the mold sections FB2_11, . . . FB2_1m). Such an arrangement that is alternating and repeated m-fold in z-direction has the advantage that the first mold part FT1 only has to be moved by one distance unit in (±y) direction (i.e., width of a mold section) in order to align all n*m mold sections of the first mold part FT1 with corresponding mold sections of the second mold part FT2, With the injection molding device 300, n*m product parts (P1 or p2) can thus be produced in each cycle

FIGS. 6 and 7 also show a further option in which a separate injection material channel (K31, K21, K3n, K2n) leads to each of the 2n*m mold sections in the second mold part FT2. In this way, a maximal flexibility is achieved during production. In particular 3-component products can be produced with such a device without problems. Alternatively, several of the mold sections in the mold part FT2 (similar as in FIGS. 3 and 5) may not have their own injection material channel.

FIG. 8 shows an injection molding device 400 in which first mold sections FB1_1, . . . FB1_n, second mold sections FB2_1, . . . FB2_n and third mold sections FB3_1, . . . FB3_n are provided n-fold on top of each other. In addition, n additional mold sections FB1_1′, . . . FB1_n′ are present on the first mold part FT1 which typically are identical to the first mold sections FB1_1, . . . FB1_n.

Further, in this embodiment, the first mold part FT1 can rotate about an axis (which is parallel to the mold opening direction X) in the rotation direction Y. The fact that all tangents of this rotation direction are perpendicular to the mold opening direction X, allows the simplified statement that the (entire) “rotation direction Y does not lie in the form opening direction X”.

As a result, the same number of mold sections can be provided in the first mold part FT1 and on the second mold part FT2 (i.e., 2n) and after each closing of this injection molding device 400 2n injection processes occur simultaneously. In other words all present mold sections are used for an injection molding process in each cycle. Thus, n finished products (P) can be produced in each cycle with the injection molding device 400.

Analogous to the embodiment of FIGS. 6 and 7 the shown mold sections can also be optionally repeated m-fold identically in a z-direction perpendicular to the drawing plane. Further, the second mold part FT2 could also optionally carry out the rotation movement completely or partially.

FIG. 9 shows an injection molding device 500 which is a modification of the device 100 of FIG. 3. In contrast to the latter, in this case the second and third mold section FB2 and FB3 are divided to the second mold part FT2 and FT3. These two mold parts FT2 and FT3 are preferably movable independent from each other, which correspondingly increases the flexibility regarding the method processes that can be carried out. This allows production of multi component products.

FIG. 10 shows an injection molding device 600 which is configured as stack mold. On the second mold part FT2 an additional second mold section FB4 is formed beside the second mold section FB2, which additional mold section together with an additional mold part FT5 can form a (additional) cavity. In this way, two (optionally different) first product parts or second product parts can be produced simultaneously in one cycle. It is to be noted that the cavities that are formed by the mold sections FB1 and FB2 or FB5 and FB4 each have individual mold opening directions X′, which in the shown example are antiparallel which however can generally be oriented in any way relative to each other.

In the injection molding device 600, injection molding material channels are provided for all mold sections FB2, FB3, FB4, FB6 of the second mold part FT2.

FIG. 11 shows an injection molding device 700 in which the first mold part FT1 has mold sections on opposing sides which each are situated on top of one another repeated n-fold in y direction (with n=2 in the shown example). This results in the mold sections FB1_1, . . . FB1_n on the right hand side in the Figure and mirror image inverted thereto the mold sections FB1_1′, . . . FB1_n′ on the left hand side. In the shown example an individual injection material channel (K11, K1n) leads to all mentioned mold sections. Further, the first mold part FT1 is movable in a direction ±Y (parallel to the y-axis of the shown coordinate system) and in addition in a rotational direction Yr. The rotational direction Yᵣ corresponds to a rotation about the y-axis.

A second mold part FT2 and third mold part FT3 are arranged opposite the mentioned sides of the first mold part FT1. The second mold part FT2 has n (second) mold sections FB2_1, . . . FB2_n which lie on top of each other and further n (third) mold sections FB3_1, . . . FB3_n which lie on top of each other.

Analogously, the third mold part FT3 has n (fourth) mold sections FB4_1, . . . FB4_n that lie on top of each other and further n (fifth) mold sections FB5_1, . . . FB5_n lie on top of each other.

A complete production cycle with the injection molding device 700 can typically proceed as follows:

First step:

Starting from the state shown in FIG. 11, the second and third mold parts FT2, FT3 are moved against the associated mold opening directions X or X′ in order to close the device. As a result, the following mold sections form cavities with each other:
On the right hand side: FB1_1 and FB2_1, . . . FB1_n and FB2_n.

These n cavities are empty in the beginning. In them, a first product part P1 (not shown) can be injected.
On the left hand side: FB1_1′ and FB4_1, . . . FB1_n′ and FB4_n.

In these cavities a pre-product is typically already present (cf. “third step”) onto which the further material can be molded.

Second step:

The second and third mold parts FT2, FT3 are moved in the associated mold opening directions X or X′ in order to open the device. Subsequently, the first mold part FT1 is moved in (−Y) direction, i.e., downward perpendicular to the mold opening directions until it is opposed to the bottom mold sections. The prefabricated product parts are carried along by the first mold part FT1. Then, the second and third mold parts FT2, FT3 are moved against the associated mold opening directions X or X′ to close the device. As a result, the following mold sections form cavities with each other:
On the right hand side: FB1_1 and FB3_1, . . . FB1_n and FB3_n. Into these n cavities, a second product part P2 (not shown) is then molded to the first product part P1 (not shown) situated in the n cavities.
On the left hand side: FB1_1′ and FB5_1, . . . FB1_n′ and FB5_n.

In these cavities further material is molded onto the pre-product situated therein (cf. “fourth step”).

Third step:

The second and third mold parts FT2, FT3 are moved in the associated mold opening directions X or X′ to open the device. Subsequently, the first mold part FT1 is rotated by 180° in rotation direction (Yᵣ) so that the mold sections FB1_1′, . . . FB1_n′ which initially where located on the left hand side in the Figure come to lie on the right hand side and the mold sections FB1_1, . . . FB1_n which were initially on the right hand side come to lie on the left hand side. Further, the first mold part FT1 is moved in (+Y) direction upwards again until it confronts the upper mold section of the mold parts FT2, FT3. The prefabricated product parts are carried along by the first mold part FT1. Then, the second and third mold parts FT2, FT3 are moved against the associated mold opening directions X or X′ to close the device. As a result, the following mold sections form cavities with each other:
On the right hand side: FB1_1′ and FB2_1, . . . FB1_n′ and FB2_n.

As in the first step, these cavities are initially empty and a first product part P1 (not shown) can be injected again.
On the left hand side: FB1_1 and FB4_1, . . . FB1_n and FB4_n.

In this cavities a third product part P3 is molded onto the pre-product located therein which consists of the first and second product parts P1+P2.

Fourth step:

The second and third mold parts FT2, FT3 are moved in the associated mold opening directions X or X′ to open the device. Subsequently, the first mold part FT1 is moved in (−Y) direction until it confronts the bottom mold sections. The prefabricated product parts are carried along by the first mold part FT1. Then, the second and third mold parts FT2, FT3 are moved against the associated mold opening directions X or X′ to close the device. As a result, the following mold sections form cavities with each other:
On the right hand side: FB1_1′ and FB3_1, . . . FB1_n′ and FB3_n .

As in the second step in these cavities a second product part P2 is molded to the product part 1 located therein.
On the left hand side: FB1_1 and FB5_1, . . . FB1_n and FB5_n.

In these cavities a fourth product part is molded to the pre-product, which is situated in these cavities and consists of the first, second and third product parts P1+P2+P3. With this, the end product is finished.

Fifth step

The second and third mold parts FT2, FT3 are moved in the associated mold opening directions X or X′ to open the device. Subsequently, the first mold part FT1 is rotated by 180° in rotation direction (Yᵣ) so that its sides assume the position of the first step again. Further, the first mold part FT1 is again moved in (+Y) direction upwards until it confronts the upper mold sections of the mold parts FT2, FT3. The pre-made intermediate product parts are carried along by the first mold part FT1. The end product P on the other hand is removed from the injection molding device 700.

This concludes the production cycle and a new cycle can start.

In each of the explained steps another injection material (by using another injection molding material channel) can be added to the pre-product, so that a four component product would result. Optionally, two different materials can also be supplied in one of the steps (via injection material channels from the first mold part FT and the second or third form part FT2 or FT3) to produce a five component product.

In each of the described production cycles 2n end products P can be produced. Optionally, the device could also have mold sections that are repeated in z-direction analogous to FIGS. 6 and 7 to increase the production output to 2n*m.

FIG. 12 shows a top view (bottom) and a section (top) through the construction drawing of a real injection molding device 800 in the two used operational positions (left images, right images). The device is principally constructed similar to the one of FIG. 6, wherein by multiple alternating of the two mold sections of the second mold part FT2, the relative number of the unpaired mold sections per molding process can be decreased.

Generally speaking, this embodiment involves alternatingly arranged mold regions on one of the mold parts (2n+1) or blocks of m similar mold sections, wherein n, m are natural numbers, for example
FB2-FB3-FB2-FB3- . . . FB2-FB3-FB2,
   which on the other mold part are confronted by 2n complementary mold sections (or blocks of m complementary mold sections) i.e, for example
FB1-FB1-FB1-FB1- . . . FB1-FB1.

In each back and forth movement of the mold parts (in Y-direction) n mold sections (or n*m mold sections in case of the blocks) form in each case a cavity
“FB1+FB2”
   and further n mold sections (or n*m mold sections in case of the blocks) a cavity
“FB1+FB3”

Overall, n cavities are formed in each cycle and only one mold section remains unused.

Of course, the embodiments of FIGS. 1-10 can be combined with each other in different ways. For example for attaining an especially high production output, the embodiments of FIGS. 7 and 9 could be combined.

It is further noted that on the shown injection material channels (K1, K2, K11, K1n, K21, K2n, K31, K3n, K4n, K51, K5n, K5) typically means for controlling important parameters (pressure, temperature etc) are arranged which are not shown in the simplified Figures. In particular, a temperature control unit can be provided with which the temperature of the injection material in the injection material channel is maintained in a target interval (or on a target curve). When injection material is processed which is liquefied at higher temperatures such a temperature control unit typically includes a heating.

For injection material (for example liquid silicon rubber LSR) which has to be kept cool until entry into the cavity, the temperature control unit typically includes a cooling. In these cases, the mold part is heated to achieve the solidification of the injection molding material (for example by vulcanizing). The present invention offers an excellent possibility to connect these materials with conventional thermoplastic materials, because the thermal separation is much simpler and cooled and heated channels do not have to be housed in the same mold part.

In summary, the invention discloses among other things an injection molding device and an injection molding method in which a first mold part with an injection material channel and a second mold part (which preferably can also have an injection material channel) form a cavity in which a first product part can be molded. Further, the first mold part can be moved in a different direction than the mold opening direction. In this way, in particular 2-component products can be produced in that the first mold part is moved with the first product part to a third mold section with which a second cavity is formed for injection of a further injection material. By an appropriate arrangement of mold sections and injection material channels, products with three or more components can also be produced.

1-14. (canceled)

15. An injection molding method, comprising:
moving a first mold part having an injection material channel and a second mold part apart in a mold opening direction; and
moving the first mold part in another direction in an at least partially straight movement, said other direction being different from the mold opening direction.

16. An Injection molding method, comprising:
injecting a first product part in a cavity between a first pair of mold sections of a first mold part and a second mold part;
moving the first mold part and the second mold part apart in a mold opening direction;
moving the first mold part which contains an injection material channel in another direction in an at least partially straight movement said other direction being different from the mold opening direction;
joining the first mold part with the second mold part or a third mold part so that a second pair of mold sections of the first mold part and the second or third mold parts form a cavity in which the first product part is situated;
injection-molding a second product part in the second cavity to the first product part.

17. An injection molding device comprising:
a first mold part with an injection molding material channel; and
a second mold part, wherein the two mold parts can be moved apart in a form opening direction, and wherein the first mold part is movable in another direction in an at least partially straight movement, said other direction being different from the mold opening direction.

18. The injection molding device of claim 17, wherein the first mold part has a first mold section and the second mold part has a second mold section which in a joined state of the first and second mold parts form a first cavity in which a first product part can be molded.

19. The injection molding device of claim 18, further comprising a third mold section, which together with the first mold section of the first mold part or the second mold section of the second mold part in the joined state forms a second cavity in which a second product part can be molded to the first product part.

20. The injection molding device of claim 19, further comprising a third mold part, wherein the third mold section is formed on the first mold part, on the second mold part or on the third mold part.

21. The injection molding device of claim 20, further comprising a further mold section, for joining with one of the mold sections of the first, second or third mold section.

22. The Injection molding device of claim 21, wherein the further mold section is provided on the first mold part.

23. The injection molding device of claim 21, further comprising a further mold part, wherein the further mold section is provided on the further mold part.

24. The injection molding device of claim 17, further comprising multiple of those ones of the mold sections which are capable of forming a cavity with each other.

25. The injection molding device of claim 17, wherein the movement of the first mold part in the other direction is part of a rotation about an axis and/or a spiral shaped movement.

26. The injection molding device of claim 17, further comprising a temperature control unit for controlling a temperature of the injection molding material channel.

27. The injection molding device of claim 26, wherein the temperature control unit includes a heating and/or a cooling.

28. The injection molding device of claim 27, wherein the temperature control unit including the heating is arranged in one of the mold parts and the temperature control unit including the cooling is arranged in another one of the mold parts.
